(19) United States
(12) Patent Application Publication
(10) Pub. No.: US 2026/0353317 A1
(43) Pub. Date: Nov. 5, 2026

(54) SSB TRANSMISSION METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Kai WU, Dongguan (CN); Jiansheng CAI, Dongguan (CN); Lihui WANG, Dongguan (CN)

(73) Assignee: VIVO MOBILE COMMUNICATION CO., LTD., Dongguan (CN)

(21) Appl. No.: 19/713,707

(22) Filed: Jun. 18, 2026

Related U.S. Application Data
(63) Continuation of application No. PCT/CN2024/140138, filed on Dec. 18, 2024.

(30) Foreign Application Priority Data
Dec. 22, 2023 (CN) 202311794187.2

(51) Int. Cl. H04W 56/00; H04W 72/0453

(52) U.S. Cl. CPC H04W 56/001; H04W 72/0453

(57) ABSTRACT

This application discloses an SSB transmission method and apparatus, a communication device, and a storage medium, and belongs to the field of wireless communication technologies. The SSB transmission method in embodiments of this application includes: sending, by a first device, an SSB by using a first bandwidth, where the first bandwidth is greater than or equal to a preset bandwidth, and the preset bandwidth is an initial receive bandwidth used by a second device to receive the SSB.

### CROSS-REFERENCE TO RELATED APPLICATIONS

The present application is a U.S. continuation application of International Application No. PCT/CN2024/140138, filed on Dec. 18, 2024, which claims priority to Chinese Patent Application No. 202311794187.2, filed in China on Dec. 22, 2023, both of which are incorporated herein by reference in their entireties.

### TECHNICAL FIELD

This application belongs to the field of wireless communication technologies, and specifically relates to an SSB transmission method and apparatus, a communication device, and a storage medium.

### BACKGROUND

In a cellular network system in the related art, a synchronization signal block (Synchronization Signal block, SSB) is mainly transmitted by using a fixed bandwidth, that is, a transmit end sends the SSB by using a fixed bandwidth, and a receive end receives the SSB by using a fixed bandwidth. As a result, a network-side device cannot obtain more reliable transmission performance by using a larger bandwidth.

### SUMMARY

According to a first aspect, an SSB transmission method is provided, including:
sending, by a first device, an SSB by using a first bandwidth, where the first bandwidth is greater than or equal to a preset bandwidth, and the preset bandwidth is an initial receive bandwidth used by a second device to receive the SSB.

According to a second aspect, an SSB transmission method is provided, including:
receiving, by a second device, an SSB by using a preset bandwidth, where the preset bandwidth is less than or equal to a first bandwidth, and the first bandwidth is a bandwidth used by a first device to send the SSB.

According to a third aspect, an SSB transmission apparatus is provided, including:
a first sending module, configured to send an SSB by using a first bandwidth, where the first bandwidth is greater than or equal to a preset bandwidth, and the preset bandwidth is an initial receive bandwidth used by a second device to receive the SSB.

According to a fourth aspect, an SSB transmission apparatus is provided, including:
a first receiving module, configured to receive an SSB by using a preset bandwidth, where the preset bandwidth is less than or equal to a first bandwidth, and the first bandwidth is a bandwidth used by a first device to send the SSB.

According to a fifth aspect, a communication device is provided. The communication device includes a processor and a memory, the memory stores a program or instructions capable of running on the processor, and the program or the instructions are executed by the processor to implement the steps of the method according to the first aspect or the second aspect.

According to a sixth aspect, a communication device is provided, including a processor and a communication interface. The communication interface is configured to send an SSB by using a first bandwidth, where the first bandwidth is greater than or equal to a preset bandwidth, and the preset bandwidth is an initial receive bandwidth used by a second device to receive the SSB.

According to a seventh aspect, a communication device is provided, including a processor and a communication interface. The communication interface is configured to receive an SSB by using a preset bandwidth, where the preset bandwidth is less than or equal to a first bandwidth, and the first bandwidth is a bandwidth used by a first device to send the SSB.

According to an eighth aspect, a readable storage medium is provided. The readable storage medium stores a program or instructions, and the program or the instructions are executed by a processor to implement the steps of the method according to the first aspect, or implement the steps of the method according to the second aspect.

According to a ninth aspect, a wireless communication system is provided, including a first device and a second device. The first device may be configured to perform the steps of the method according to the first aspect, and the second device may be configured to perform the steps of the method according to the second aspect.

According to a tenth aspect, a chip is provided. The chip includes a processor and a communication interface. The communication interface is coupled to the processor. The processor is configured to run a program or instructions to implement the method according to the first aspect, or implement the method according to the second aspect.

According to an eleventh aspect, a computer program/program product is provided. The computer program/program product is stored in a storage medium, and the program/program product is executed by at least one processor to implement the steps of the method according to the first aspect or the second aspect.

### BRIEF DESCRIPTION OF DRAWINGS

FIG. 1 is a block diagram of a wireless communication system to which an embodiment of this application is applicable;

FIG. 2 is a schematic diagram of a structure of a synchronization signal block;

FIG. 3 is a schematic diagram of a waveform of an on-off keying signal;

FIG. 4 is a schematic diagram of an OOK-1 waveform of a low-power signal;

FIG. 5 is a schematic diagram of an OOK-4 waveform of a low-power signal;

FIG. 6 is a schematic diagram of a receiving characteristic of an OOK/ASK signal;

FIG. 7 is a schematic diagram of a transmission manner of two parts of an SSB according to an embodiment of this application;

FIG. 8 is a first schematic flowchart of an SSB transmission method according to an embodiment of this application;

FIG. 9 is a schematic diagram of a transmit bandwidth and a receive bandwidth of a low-power signal according to an embodiment of this application;

FIG. 10 is a second schematic flowchart of an SSB transmission method according to an embodiment of this application;

FIG. 11 is a third schematic flowchart of an SSB transmission method according to an embodiment of this application;

FIG. 12 is a fourth schematic flowchart of an SSB transmission method according to an embodiment of this application;

FIG. 13 is a schematic diagram in which a bandwidth of a receive end is less than or equal to a bandwidth of a transmit end according to an embodiment of this application;

FIG. 14 is a schematic diagram in which a bandwidth of a receive end is greater than or equal to a bandwidth of a transmit end according to an embodiment of this application;

FIG. 15 is a first schematic diagram of a structure of an SSB transmission apparatus according to an embodiment of this application;

FIG. 16 is a second schematic diagram of a structure of an SSB transmission apparatus according to an embodiment of this application;

FIG. 17 is a third schematic diagram of a structure of an SSB transmission apparatus according to an embodiment of this application;

FIG. 18 is a fourth schematic diagram of a structure of an SSB transmission apparatus according to an embodiment of this application;

FIG. 19 is a schematic diagram of a structure of a communication device according to an embodiment of this application;

FIG. 20 is a schematic diagram of a hardware structure of a terminal according to an embodiment of this application; and

FIG. 21 is a schematic diagram of a hardware structure of a network-side device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as follows: A transmitter explicitly notifies, in a sent indication, a receiver of specific information, an operation that needs to be performed, a requested result, or other content. The indirect indication may be understood as follows: The receiver determines corresponding information based on the indication sent by the transmitter, or performs determining based on the indication sent by the transmitter, and determines, based on a determining result, the operation that needs to be performed, the requested result, or the like.

It should be noted that a technology described in the embodiments of this application is not limited to a long term evolution (Long Term Evolution, LTE)/LTE-advanced (LTE-Advanced, LTE-A) system, and may be further applied to another wireless communication system, such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency-division multiple access (Single-carrier Frequency-Division Multiple Access, SC-FDMA) system, or another system. The terms “system” and “network” are often used interchangeably in the embodiments of this application. The technology described may be used for the systems and radio technologies described above, as well as other systems and radio technologies. The following describes a new radio (New Radio, NR) system for illustrative purposes, and NR terms are used in most of the following descriptions. However, these technologies are also applicable to systems such as a 6th generation (6th Generation, 6G) communication system other than the NR system.

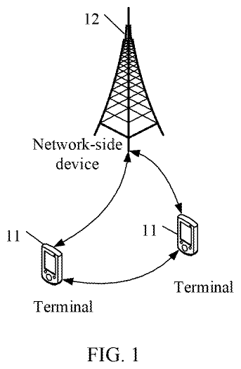

FIG. 1 is a block diagram of a wireless communication system to which an embodiment of this application is applicable. The wireless communication system includes a terminal 11 and a network-side device 12. The terminal 11 may be a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR)/virtual reality (Virtual Reality, VR) device, a robot, a wearable device (Wearable Device), a flight vehicle (flight vehicle), vehicle user equipment (Vehicle User Equipment, VUE), ship-mounted equipment, pedestrian user equipment (Pedestrian User Equipment, PUE), a smart home (a home device with a wireless communication function, for example, a refrigerator, a television, a washing machine, or a piece of furniture), a game console, a personal computer (Personal Computer, PC), a teller machine, a self-service machine, or another terminal-side device. The wearable device includes: a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application. The network-side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AS), a wireless fidelity (Wireless Fidelity, Wi-Fi) node, and the like. The base station may be referred to as a NodeB (Node B, NB), an evolved NodeB (Evolved Node B, eNB), a next generation NodeB (the next generation Node B, gNB), a new radio NodeB (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home Node B, HNB), a home evolved NodeB (home evolved Node B), a transmission reception point (Transmission Reception Point, TRP), or another proper term in the art. The base station is not limited to a specific technical term, provided that same technical effects are achieved. It should be noted that in the embodiments of this application, only a base station in an NR system is used as an example for description, and a specific type of the base station is not limited.

The following briefly describes related technical content in this application.

### 1. Classification and Features of Artificial Intelligence Internet of Things (Artificial Intelligence Internet of Things, A-IoT) Devices in Third Generation Partnership Projects (Third Generation Partnership Projects, 3GPP)

In the 3GPP R19 A-IoT study, an ambient internet of things device is represented based on an energy storage capacity of the ambient internet of things device and a capability to generate a radio frequency signal for transmission. The A-IoT device has one of the following energy storage capabilities:
Storage capacity 1: There is no capability to store energy.
Storage capacity 2: Energy can be stored up to E1 or E2 joules, where it is possible that E1=E2.
Storage capacity 3: Energy can be stored up to E2 joules.

Depending on these storage capacities, the study considers the following types of ambient internet of things devices:
Device A: The device has no capability of energy storage and no capability of independent signal generation/amplification, that is, performs backscatter transmission.
Device B: The device has a capability of energy storage but no capability of independent signal generation, that is, performs backscatter transmission. The use of stored energy may include amplification of a reflected signal.
Device C: The device has a capability of energy storage and has a capability of independent signal generation, that is, has an active radio frequency component for transmission.

### 2. Synchronization Signal and Physical Broadcast Channel (Physical Broadcast Channel, PBCH) in Fifth-Generation New RAT (5th-Generation, 5G NR)

A wireless device (terminal) obtains a synchronization signal and a broadcast signal/channel from a cell of a base station by using a cell search process, to perform time-frequency synchronization with the base station, and obtain a time-domain location and a frequency-domain location of a time-frequency resource of the cell deployed by the base station, as well as a physical cell identity (Identity, ID).

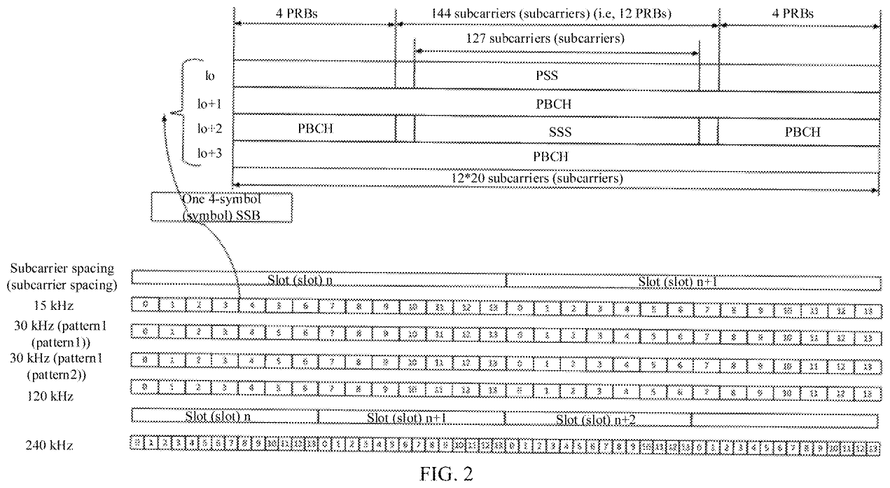

In 5G, a structure of an SSB is shown in FIG. 2, and the SSB includes a primary synchronization signal (Primary Synchronization Signal, PSS), a secondary synchronization signal (Secondary Synchronization Signal, SSS), and a PBCH.

The terminal first detects the PSS to obtain a part of the physical cell ID, namely,

$${N}_{ID}^{( 2 )} ;$$

obtains orthogonal frequency division multiplexing (OFDM) symbol timing and frequency synchronization; and then detects the SSS to obtain another part of the physical cell ID, namely,

$${N}_{ID}^{( 1 )} ,$$

to obtain the complete physical cell ID, namely,

$$PCI = {N}_{ID}^{cell} = 3 {N}_{ID}^{( 1 )} + {N}_{ID}^{( 2 )} .$$

Then, the terminal detects the PBCH and demodulates the PBCH by using a demodulation reference signal (Demodulation Reference Signal, DMRS), to obtain a system frame number (System Frame Number, SFN) and an SSB index, and further obtain radio subframe (subframe) timing.

A waveform in new radio (New Radio, NR) is based on an OFDM waveform. A network performs transmission by using a determined parameter such as a bandwidth and a subcarrier spacing, and the terminal receives the SSB in a case that the terminal explicitly knows a parameter such as a transmit bandwidth of the SSB and a subcarrier spacing.

### 3. Low-Power Signal Waveform

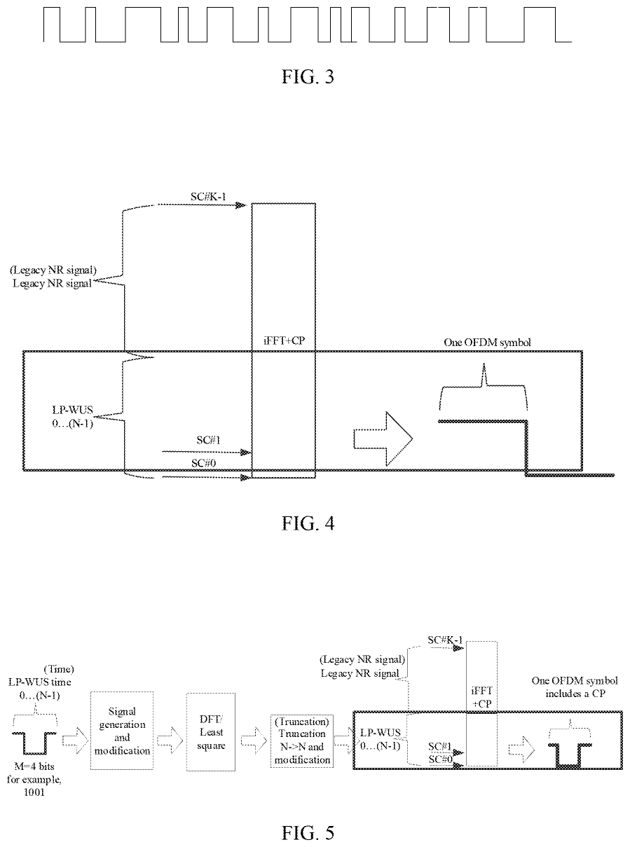

To reduce power consumption of low power wake-up radio (low power wake-up radio, LP WUR) and achieve power saving, a low-power signal is generally sent by using a simple waveform, such as on-off keying (on-off keying, OOK, as shown in FIG. 3) or frequency-shift keying (Frequency-shift keying, FSK). Therefore, the terminal may identify the low-power signal through simple energy detection, frequency detection, or the like.

Currently, two potential low-power signal waveforms include OOK-1 and OOK-4. The two waveforms belong to amplitude modulation, and therefore same modulation is applied across all subcarriers. That is, no frequency-domain resource is used.

As shown in FIG. 4, a characteristic of an OOK-1 waveform of the low-power signal is that one bit is included within a length of one OFDM symbol. As shown in FIG. 4, the OOK-1 waveform includes one high-level bit.

As shown in FIG. 5, a characteristic of an OOK-4 waveform of the low-power signal is that M bits/chips are included within a length of one OFDM symbol. In FIG. 5, M=4. For example, the OOK-4 waveform in FIG. 5 includes four bits: a high-level bit, a low-level bit, a low-level bit, and a high-level bit (that is, 1001).

In practice, it may be understood that a difference between OOK-1 and OOK-4 lies in whether one OFDM symbol can carry more than one OOK bit.

It should be noted that one bit “0” or “1” may be understood as one chip.

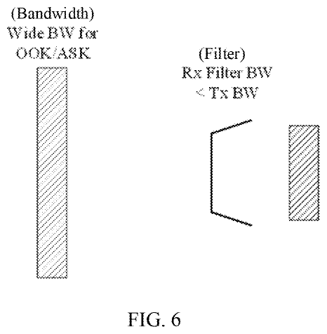

For receiving of an OOK/amplitude-shift keying (Amplitude-Shift Keying, ASK) signal, the following characteristic exists: If a transmit bandwidth (T×BW) of an OOK signal on a transmit side is X, a receive bandwidth (R×BW) of a receive end is Y, and X>Y, the receive end can still detect the OOK signal, as shown in FIG. 6.

### 4. Deployment Bandwidth of an A-IoT/Low-Power Transmission System

Bandwidths used by different operators to deploy an A-IoT/terminal device may be different. Generally, the protocol specifies a minimum bandwidth of an SSB for the A-IoT/terminal. However, some operators have more bandwidths available for SSB sending. In this case, the foregoing limitation restricts an operator with more spectrum resources from sending the SSB by using a larger bandwidth.

### 5. SSB Transmission Period in the A-IoT/Low-Power Transmission System

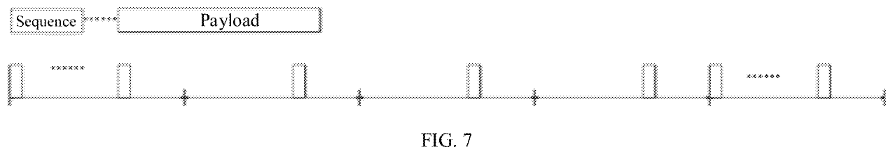

An SSB may include different signal parts, such as a sequence (sequence) part and a payload (payload) part. The sequence part is mainly used for synchronization and measurement, and the SSB may include one or more sequence parts. The payload part is used to carry a broadcast information bit, which may be coded or not coded; may be line-coded, where line coding includes, for example, Manchester, FM0, Miller, or PIE coding; may be channel-coded; or may have a cyclic redundancy check (Cyclic Redundancy Check, CRC) bit added. The sequence part and the payload part may be continuous in time during transmission and transmitted by using a same period. Alternatively, the sequence part and the payload part may be discontinuous in time during transmission and/or transmitted by using different periods, that is, the following cases may be included: The sequence part and the payload part may be discontinuous in time during transmission; the sequence part and the payload part may be transmitted by using different periods; the sequence part and the payload part may be discontinuous in time during transmission and transmitted by using different periods, as shown in FIG. 7.

With reference to the accompanying drawings, an SSB transmission method and apparatus, a communication device, and a storage medium that are provided in the embodiments of this application are described in detail below by using some embodiments and application scenarios thereof.

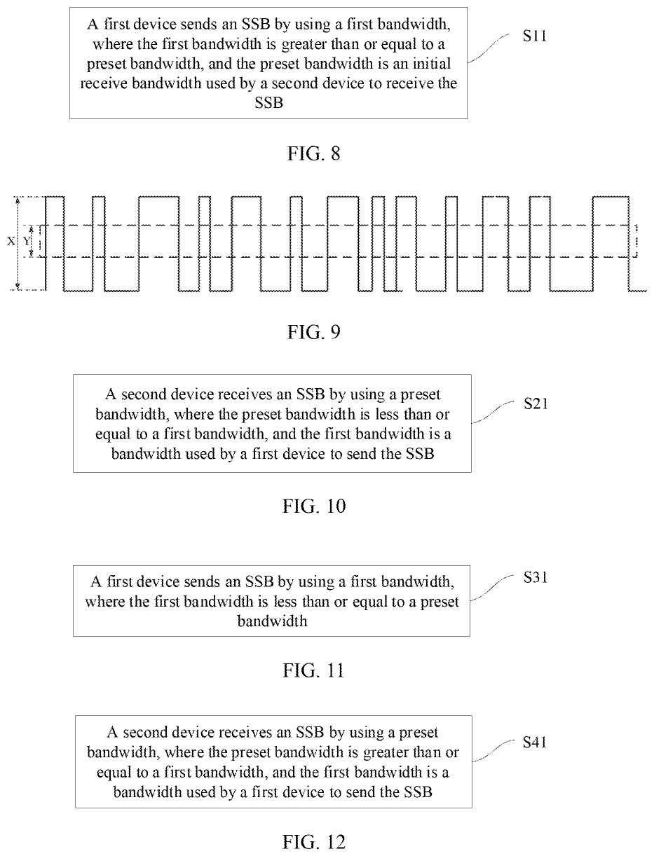

Referring to FIG. 8, an embodiment of this application provides an SSB transmission method, including:

Step S11: A first device sends an SSB by using a first bandwidth, where the first bandwidth is greater than or equal to a preset bandwidth, and the preset bandwidth is an initial receive bandwidth used by a second device to receive the SSB.

Optionally, the preset bandwidth is a bandwidth agreed upon by the protocol.

The initial receive bandwidth refers to a receive bandwidth initially used by the second device. After receiving the SSB by using the initial receive bandwidth, the second device may also change the receive bandwidth based on a requirement.

In this embodiment of this application, optionally, the first device sends the SSB to the second device by using the first bandwidth.

Optionally, the first device may be a handheld or fixed device that reads or writes information about an internet of things (Internet of Things, IoT)/low-power device. The first device may also be understood as a device that communicates with the IoT/low-power device, for example, may be a terminal, may be a base station, or may be a device that has a read/write function, for example, a reader/writer. This is not limited herein.

Optionally, in a possible implementation, the second device may be a tag, namely, a radio frequency identification (Radio Frequency Identification, RFID) tag. A radio frequency identification technology may fall into three types: active, passive, and semi-active. The passive tag may also be referred to as a passive IOT, namely, a passive internet of things device. A communication manner of the second device may be as follows: Signal transmission is performed by backscattering a radio frequency (Radio Frequency, RF) signal, or some active tags may also have a capability of actively generating a signal. Because energy of the second device may come from an environment, for example, ambient RF energy, thermal energy, wind energy, or kinetic energy, the second device may also be referred to as an ambient Internet of Thing (Ambient IoT, A-IoT) device. The second device may also be broadly understood as a terminal, especially a terminal device used for low-power communication.

In this embodiment of this application, an SSB transmit end sends the SSB by using the first bandwidth greater than or equal to the preset bandwidth, and the preset bandwidth is the initial receive bandwidth used by an SSB receive end, so that more reliable transmission performance can be obtained by using a larger bandwidth.

In this embodiment of this application, optionally, the first device sends the SSB by using a low-power signal waveform. Optionally, the low-power signal waveform may include an OOK waveform or an ASK waveform. The low-power signal waveform such as OOK/ASK has the following characteristics: If a transmit bandwidth of a low-power signal on a transmit side is X, a receive bandwidth of a receive end is Y, and X>Y, the receive end can still demodulate the low-power signal (as shown in FIG. 9, a signal in FIG. 9 is an OOK signal; it can be learned from FIG. 9 that due to a characteristic of the OOK signal, the receive end does not need to obtain the OOK signal over the entire transmit bandwidth, but only needs to obtain the OOK signal over a part of the transmit bandwidth, and can still obtain content of the OOK signal through parsing). This characteristic enables a network operator with more spectrum resources to transmit an SSB by using a larger bandwidth, and the receive end can still search for and detect the SSB.

In some embodiments, optionally, the first bandwidth is M times the preset bandwidth, and M is greater than or equal to 1. After M is obtained, the first bandwidth may be determined based on the preset bandwidth and M. Optionally, M may be agreed upon by the protocol. Further, optionally, M is an integer greater than or equal to 1. That is, the first bandwidth is an integer multiple of the preset bandwidth, thereby facilitating implementation.

In some embodiments, optionally, the SSB transmission method further includes: The first device selects the first bandwidth from a preset set of first bandwidths. Optionally, the set of first bandwidths is agreed upon by the protocol. The set of first bandwidths is agreed upon, so that a range for selecting the first bandwidth by the SSB transmit end is wider, and a first bandwidth greater than or equal to the receive bandwidth can be selected, based on a requirement, to send the SSB, thereby improving flexibility of selecting a bandwidth for sending the SSB by the SSB transmit end.

In some embodiments, optionally, the SSB transmission method further includes: The first device selects M from a preset set of multiples, and determines the first bandwidth based on the selected M and the preset bandwidth, where the first bandwidth is M times the preset bandwidth, and M is greater than or equal to 1. Optionally, the set of multiples is agreed upon by the protocol. The set of multiples is agreed upon, so that a range for selecting M by the SSB transmit end is wider, thereby improving flexibility of selecting a bandwidth for sending the SSB by the SSB transmit end.

In some embodiments, optionally, the SSB transmission method further includes: The first device sends indication information, where the indication information is used to indicate the first bandwidth or M, the first bandwidth is M times the preset bandwidth, and M is greater than or equal to 1. Optionally, after the first device sends the SSB by using the first bandwidth, the first device sends the indication information. Optionally, the first device sends the indication information to the second device. Therefore, the SSB receive end can obtain an actual transmit bandwidth of the first device, and can receive a subsequent signal based on the actual transmit bandwidth, thereby improving receiving reliability.

In some embodiments, optionally, the indication information is indicated by using the SSB or system information. The indication information is indicated by using the SSB, so that the SSB receive end can obtain the indication information while obtaining the SSB, which is convenient and fast. In this embodiment of this application, the system information may be information sent independently of the SSB, or maybe system information carried by the SSB. This is not limited in this application. The system information is, for example, a master information block (master information block, MIB) or a system information block (System Information Block, SIB).

In some embodiments, optionally, that the indication information is indicated by using the SSB includes one of the following:
the indication information is indicated by using a synchronization sequence in the SSB;
the indication information is indicated by using an information bit (payload part) of a physical broadcast channel (PBCH) in the SSB; and
the indication information is indicated through cyclic redundancy check (CRC) scrambling of the information bit of the physical broadcast channel in the SSB.

It should be noted that the foregoing indication by using the SSB may be either a direct indication (or an explicit indication) or an indirect indication (or an implicit indication). The direct indication may be understood as follows: A transmitter explicitly notifies a receiver of content of the indication information in a sent indication. The indirect indication may be understood as follows: The receiver determines corresponding indication information based on the indication sent by the transmitter.

In some embodiments, optionally, the SSB includes at least one of the synchronization sequence and the physical broadcast channel.

In some embodiments, optionally, the synchronization sequence and the physical broadcast channel may be continuous in time and transmitted by using a same period.

In some embodiments, optionally, that a first device sends an SSB by using a first bandwidth includes: The first device sends the synchronization sequence and the physical broadcast channel by using different periods. Therefore, a sending manner is more flexible.

In some embodiments, optionally, the SSB transmission method further includes: The first device sends at least one of the following by using the first bandwidth:
a control channel;
a data channel; and
a measurement signal, where the measurement signal may include, for example, at least one of the following: a measurement reference signal and a demodulation reference signal.

Optionally, the first device sends the foregoing signal by using a low-power signal waveform. Optionally, the low-power signal waveform includes an OOK waveform or an ASK waveform. That is, the first device sends the SSB and some other signals by using the same first bandwidth, without changing the transmit bandwidth. The receive end can demodulate a low-power signal.

In some embodiments, optionally, the SSB transmission method further includes:

The first device receives capability information of the second device, where the capability information includes a receive bandwidth capability of the second device; and
the first device determines the first bandwidth based on the receive bandwidth capability of the second device.

In this embodiment of this application, the first device determines the first bandwidth based on the receive bandwidth capability of the second device. This can improve receiving performance of the second device.

Referring to FIG. 10, an embodiment of this application further provides an SSB transmission method, including:

Step S21: A second device receives an SSB by using a preset bandwidth, where the preset bandwidth is less than or equal to a first bandwidth, and the first bandwidth is a bandwidth used by a first device to send the SSB.

Optionally, the preset bandwidth is a bandwidth agreed upon by the protocol.

Optionally, the first device may be a handheld or fixed device that reads or writes information about an internet of things (Internet of Things, IoT)/low-power device. The first device may also be understood as a device that communicates with the IoT/low-power device, for example, may be a terminal, may be a base station, or may be a device that has a read/write function, for example, a reader/writer. This is not limited herein.

Optionally, in a possible implementation, the second device may be a tag, namely, a radio frequency identification (Radio Frequency Identification, RFID) tag. A radio frequency identification technology may fall into three types: active, passive, and semi-active. The passive tag may also be referred to as a passive IOT, namely, a passive internet of things device. A communication manner of the second device may be as follows: Signal transmission is performed by backscattering a radio frequency (Radio Frequency, RF) signal, or some active tags may also have a capability of actively generating a signal. Because energy of the second device may come from an environment, for example, ambient RF energy, thermal energy, wind energy, or kinetic energy, the second device may also be referred to as ambient Internet of Thing (Ambient IoT, A-IoT). The second device may also be broadly understood as a terminal, especially a terminal device used for low-power communication.

In this embodiment of this application, an SSB receive end receives the SSB by using the preset bandwidth, where the preset bandwidth is less than or equal to the first bandwidth, and the first bandwidth is a bandwidth used by the first device to send the SSB. Therefore, the receive end can receive a signal by using the preset bandwidth in a case that the receive end does not know an actual transmit bandwidth of a low-power signal, without increasing receiver complexity, and the receive end can still receive the SSB, thereby reducing receiving complexity of the SSB, and improving downlink channel transmission performance.

In this embodiment of this application, optionally, the first device sends the SSB by using a low-power signal waveform. Optionally, the low-power signal waveform may include an OOK waveform or an ASK waveform. The low-power signal waveform such as OOK/ASK has the following characteristics: If a transmit bandwidth of a low-power signal on a transmit side is X, a receive bandwidth of the receive end is Y, and X>Y, the receive end can still demodulate the low-power signal (for example, by using an envelope detection or amplitude/power detection method, where in a case that the receive bandwidth is less than the transmit bandwidth, the receive end can still detect the OOK/ASK waveform). This characteristic enables a network operator with more spectrum resources to transmit an SSB by using a larger bandwidth, and the receive end can still search for and detect the SSB.

In some embodiments, optionally, the first bandwidth is M times the preset bandwidth, and M is greater than or equal to 1. After M is obtained, the first bandwidth may be determined based on the preset bandwidth and M. Optionally, M may be agreed upon by the protocol. Further, optionally, M is an integer greater than or equal to 1. That is, the first bandwidth is an integer multiple of the preset bandwidth, thereby facilitating implementation.

In some embodiments, optionally, the SSB transmission method further includes: The second device receives indication information, where the indication information is used to indicate the first bandwidth or M, the first bandwidth is M times the preset bandwidth, and M is greater than or equal to 1. Optionally, the second device receives the indication information sent by the first device. Therefore, the SSB receive end can obtain an actual transmit bandwidth of the first device, and can receive a subsequent signal based on the actual transmit bandwidth, thereby improving receiving reliability.

In some embodiments, optionally, the indication information is indicated by using the SSB or system information. The indication information is indicated by using the SSB, so that the SSB receive end can obtain the indication information while obtaining the SSB, which is convenient and fast. In this embodiment of this application, the system information may be information sent independently of the SSB, or may be system information carried by the SSB. This is not limited in this application. The system information is, for example, a master information block (master information block, MIB) or a system information block (System Information Block, SIB).

In some embodiments, optionally, that the indication information is indicated by using the SSB includes one of the following:
the indication information is indicated by using a synchronization sequence in the SSB;
the indication information is indicated by using an information bit of a physical broadcast channel (PBCH) in the SSB; and
the indication information is indicated through cyclic redundancy check (CRC) scrambling of the information bit of the physical broadcast channel in the SSB.

It should be noted that the foregoing indication by using the SSB may be either a direct indication (or an explicit indication) or an indirect indication (or an implicit indication). The direct indication may be understood as follows: A transmitter explicitly notifies a receiver of content of the indication information in a sent indication. The indirect indication may be understood as follows: The receiver determines corresponding indication information based on the indication sent by the transmitter.

In some embodiments, optionally, the SSB includes at least one of the synchronization sequence and the physical broadcast channel.

In some embodiments, optionally, the synchronization sequence and the physical broadcast channel may be continuous in time and transmitted by using a same period.

In some embodiments, optionally, the synchronization sequence and the physical broadcast channel may be discontinuous in time. Further optionally, the synchronization sequence and the physical broadcast channel are transmitted by using different periods.

In some embodiments, optionally, after the second device receives the indication information, the method further includes: The second device receives at least one piece of the following information by using the first bandwidth:
the SSB;
the physical broadcast channel;
a control channel;
a data channel; and
a measurement signal, where the measurement signal may include, for example, at least one of the following: a measurement reference signal and a demodulation reference signal.

For example, it is assumed that the first bandwidth is indicated in the synchronization sequence, and the receive end receives the synchronization sequence, but has not received the physical broadcast channel. In this case, the receive end may know the first bandwidth, and receive the physical broadcast channel by using the first bandwidth.

Receiving performance of the second device can be improved by receiving the foregoing signal by using the first bandwidth. Certainly, it should be noted that the second device needs to have a receive bandwidth capability that supports the first bandwidth.

For second devices that have different bandwidth capabilities, some receiving metrics are also different because receiving quality is different. For example, a device that has only a capability of the preset bandwidth is limited by a relatively small receive bandwidth, and needs to receive the SSB or the measurement signal a plurality of times to obtain measurement performance that meets a requirement. As a result, a time for synchronization, reselection, or handover becomes longer. A device with a relatively large receive bandwidth may meet a measurement performance requirement by using a relatively small quantity of receiving times. Therefore, a time for synchronization, reselection, or handover is also relatively short.

In some embodiments, optionally, the SSB transmission method further includes: The second device determines a receiving metric based on at least one of the first bandwidth and the preset bandwidth.

In some embodiments, optionally, the receiving metric includes at least one of the following:
a measurement accuracy metric;
a measurement evaluation period;
a measurement result reporting period; and
a quantity of measurements per unit period.

In some embodiments, optionally, the SSB transmission method further includes: The second device reports capability information of the second device, where the capability information includes a receive bandwidth capability of the second device.

In this embodiment of this application, the first device can determine the first bandwidth based on the receive bandwidth capability of the second device, and perform transmission by using an appropriate bandwidth.

Optionally, the receive bandwidth capability may include at least one of the following: a supported bandwidth size and a set of supported receive bandwidths.

For a low-power signal such as an OOK signal, a transmit bandwidth of the SSB may affect a signal of another communication system (such as NR) on an adjacent frequency.

To reduce an impact of the low-power signal on the signal of the another communication system on the adjacent frequency, referring to FIG. 11, an embodiment of this application further provides an SSB transmission method, including:

Step S31: A first device sends an SSB by using a first bandwidth, where the first bandwidth is less than or equal to a preset bandwidth.

Optionally, the preset bandwidth is a bandwidth agreed upon by the protocol.

In this embodiment of this application, optionally, the first device sends the SSB to the second device by using the first bandwidth.

Optionally, the first device may be a handheld or fixed device that reads or writes information about an internet of things (Internet of Things, IoT)/low-power device. The first device may also be understood as a device that communicates with the IoT/low-power device, for example, may be a terminal, may be a base station, or may be a device that has a read/write function, for example, a reader/writer. This is not limited herein.

Optionally, in a possible implementation, the second device may be a tag, namely, a radio frequency identification (Radio Frequency Identification, RFID) tag. A radio frequency identification technology may fall into three types: active, passive, and semi-active. The passive tag may also be referred to as a passive IOT, namely, a passive internet of things device. A communication manner of the second device may be as follows: Signal transmission is performed by backscattering a radio frequency (Radio Frequency, RF) signal, or some active tags may also have a capability of actively generating a signal. Because energy of the second device may come from an environment, for example, ambient RF energy, thermal energy, wind energy, or kinetic energy, the second device may also be referred to as ambient Internet of Thing (Ambient IoT, A-IoT). The second device may also be broadly understood as a terminal, especially a terminal device used for low-power communication.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

In some embodiments, optionally, the SSB transmission method further includes: The first device selects the first bandwidth from a preset set of first bandwidths. Optionally, the set of first bandwidths is agreed upon by the protocol. The set of first bandwidths is agreed upon, so that a range for selecting the first bandwidth by the SSB transmit end is wider, and a first bandwidth greater than or equal to the receive bandwidth can be selected, based on a requirement, to send the SSB, thereby improving flexibility of selecting a bandwidth for sending the SSB by the SSB transmit end.

In some embodiments, optionally, the SSB transmission method further includes: The first device sends indication information, where the indication information is used to indicate the first bandwidth. Optionally, after the first device sends the SSB by using the first bandwidth, the first device sends the indication information. Optionally, the first device sends the indication information to the second device. Therefore, the SSB receive end can obtain an actual transmit bandwidth of the first device, and can receive a subsequent signal based on the actual transmit bandwidth, thereby improving receiving reliability.

In some embodiments, optionally, the indication information is indicated by using the SSB or system information. The indication information is indicated by using the SSB, so that the SSB receive end can obtain the indication information while obtaining the SSB, which is convenient and fast. In this embodiment of this application, the system information may be information sent independently of the SSB, or may be system information carried by the SSB. This is not limited in this application. The system information is, for example, a master information block (master information block, MIB) or a system information block (System Information Block, SIB).

In some embodiments, optionally, that the indication information is indicated by using the SSB includes one of the following:
the indication information is indicated by using a synchronization sequence in the SSB;
the indication information is indicated by using an information bit (payload part) of a physical broadcast channel (PBCH) in the SSB; and
the indication information is indicated through cyclic redundancy check (CRC) scrambling of the information bit of the physical broadcast channel in the SSB.

It should be noted that the foregoing indication by using the SSB may be either a direct indication (or an explicit indication) or an indirect indication (or an implicit indication). The direct indication may be understood as follows: A transmitter explicitly notifies a receiver of content of the indication information in a sent indication. The indirect indication may be understood as follows: The receiver determines corresponding indication information based on the indication sent by the transmitter.

In some embodiments, optionally, the SSB includes at least one of the synchronization sequence and the physical broadcast channel.

In some embodiments, optionally, the synchronization sequence and the physical broadcast channel may be continuous in time and transmitted by using a same period.

In some embodiments, optionally, that a first device sends an SSB by using a first bandwidth includes: The first device sends the synchronization sequence and the physical broadcast channel by using different periods. Therefore, a sending manner is more flexible.

In some embodiments, optionally, after the first device sends the indication information, the method further includes: The first device receives, by using the first bandwidth, a signal sent by the second device. That is, after knowing the transmit bandwidth of the first device, the second device may send a signal to the first device by using the same bandwidth, to improve receiving performance of the first device.

In some embodiments, optionally, the SSB transmission method further includes: The first device sends at least one of the following by using the first bandwidth:
a control channel;
a data channel; and
a measurement signal, where the measurement signal may include, for example, at least one of the following: a measurement reference signal and a demodulation reference signal.

In this embodiment of this application, optionally, the first device sends the SSB by using a low-power signal waveform. Optionally, the low-power signal waveform may include an OOK waveform or an ASK waveform.

Referring to FIG. 12, an embodiment of this application provides an SSB transmission method, including:

Step S41: A second device receives an SSB by using a preset bandwidth, where the preset bandwidth is greater than or equal to a first bandwidth, and the first bandwidth is a bandwidth used by a first device to send the SSB.

Optionally, the preset bandwidth is a bandwidth agreed upon by the protocol.

In this embodiment of this application, optionally, the first device sends the SSB to the second device by using the first bandwidth.

Optionally, the first device may be a handheld or fixed device that reads or writes information about an internet of things (Internet of Things, IoT)/low-power device. The first device may also be understood as a device that communicates with the IoT/low-power device, for example, may be a terminal, may be a base station, or may be a device that has a read/write function, for example, a reader/writer. This is not limited herein.

Optionally, in a possible implementation, the second device may be a tag, namely, a radio frequency identification (Radio Frequency Identification, RFID) tag. A radio frequency identification technology may fall into three types: active, passive, and semi-active. The passive tag may also be referred to as a passive IOT, namely, a passive internet of things device. A communication manner of the second device may be as follows: Signal transmission is performed by backscattering a radio frequency (Radio Frequency, RF) signal, or some active tags may also have a capability of actively generating a signal. Because energy of the second device may come from an environment, for example, ambient RF energy, thermal energy, wind energy, or kinetic energy, the second device may also be referred to as ambient Internet of Things (Ambient IoT, A-IoT). The second device may also be broadly understood as a terminal, especially a terminal device used for low-power communication.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

In some embodiments, optionally, the SSB transmission method further includes: The second device receives indication information, where the indication information is used to indicate the first bandwidth. Optionally, the second device receives the indication information sent by the first device. Therefore, the SSB receive end can obtain an actual transmit bandwidth of the first device, and can receive a subsequent signal based on the actual transmit bandwidth, thereby improving receiving reliability.

In some embodiments, optionally, the indication information is indicated by using the SSB or system information. The indication information is indicated by using the SSB, so that the SSB receive end can obtain the indication information while obtaining the SSB, which is convenient and fast. In this embodiment of this application, the system information may be information sent independently of the SSB, or may be system information carried by the SSB. This is not limited in this application. The system information is, for example, a master information block (master information block, MIB) or a system information block (System Information Block, SIB).

In some embodiments, optionally, that the indication information is indicated by using the SSB includes one of the following:
the indication information is indicated by using a synchronization sequence in the SSB;
the indication information is indicated by using an information bit (payload part) of a physical broadcast channel (PBCH) in the SSB; and
the indication information is indicated through cyclic redundancy check (CRC) scrambling of the information bit of the physical broadcast channel in the SSB.

It should be noted that the foregoing indication by using the SSB may be either a direct indication (or an explicit indication) or an indirect indication (or an implicit indication). The direct indication may be understood as follows: A transmitter explicitly notifies a receiver of content of the indication information in a sent indication. The indirect indication may be understood as follows: The receiver determines corresponding indication information based on the indication sent by the transmitter.

In some embodiments, optionally, after the second device receives the indication information, the method further includes: The second device sends a signal by using the first bandwidth, to improve receiving performance of the first device.

In some embodiments, optionally, the second device determines a sending metric of the signal based on the first bandwidth.

In some embodiments, optionally, the sending metric includes at least one of the following:
an in-band emission metric;
an adjacent channel leakage ratio metric; and
a spurious metric.

In some embodiments, optionally, the SSB is transmitted by using a low-power signal waveform. Optionally, the low-power signal waveform may include an OOK waveform or an ASK waveform.

The following describes an example of the SSB transmission method in this application with reference to a specific application scenario.

Embodiment 1 of this application: variable SSB sending

In a cellular system, spectrum resources that may be deployed for use by an A-IoT or low-power communication system may be different. Due to a characteristic of an OOK/ASK waveform, a transmit end (namely, a first device) may determine, based on an available bandwidth, a bandwidth for transmitting an SSB. A receive end (namely, a second device) may receive the SSB by using a relatively narrow bandwidth, and can still demodulate an OOK/ASK signal, for example, by using an envelope detection or amplitude/power detection method. In a case that a receive bandwidth is less than a transmit bandwidth, the receive end can still detect the OOK/ASK waveform.

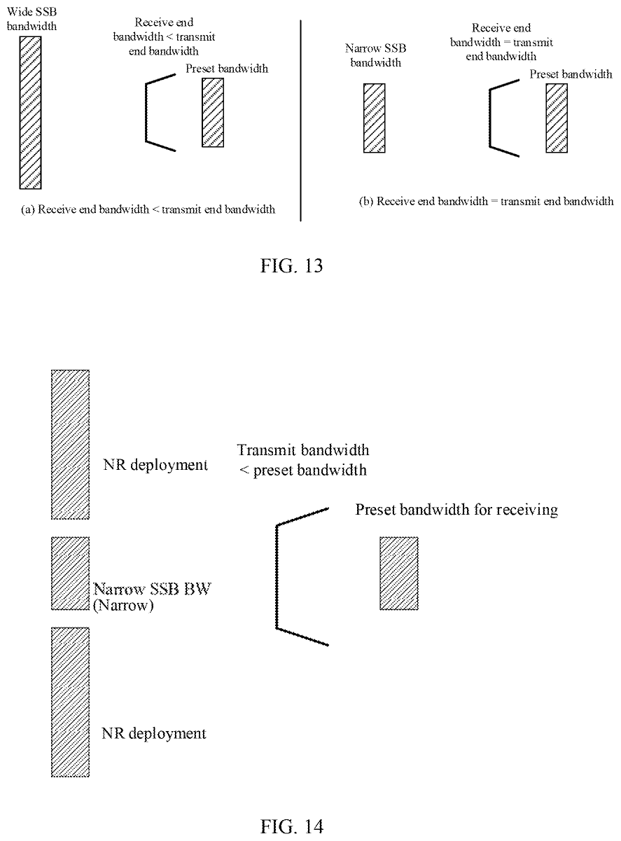

Referring to FIG. 13, the second device receives the SSB by using a preset bandwidth, and a deployment bandwidth of the A-IoT or low-power transmission system should be greater than or equal to the preset bandwidth. In a case that the second device does not know a deployment bandwidth of the first device, during SSB search, the second device may receive the SSB by using the preset bandwidth.

If the first device uses a relatively large deployment bandwidth, the SSB may be transmitted by using a larger bandwidth. In this case, the second device still receives the SSB by using the preset bandwidth. In this case, the second device may perform receiving over only a part of the SSB transmit bandwidth, but can still detect the signal and the carried information in the SSB, as shown in (a) in FIG. 13. In this case, even if the second device has a specific frequency offset, the receive bandwidth is still within the SSB transmit bandwidth. This avoids a plurality of times of SSB search due to the frequency offset, and reduces complexity of SSB search.

If the first device uses a minimum deployment bandwidth, that is, uses the preset bandwidth to transmit the SSB, the second device performs receiving by using the preset bandwidth that may match the minimum deployment bandwidth, thereby receiving the SSB, as shown in (b) in FIG. 13.

The bandwidth for sending the SSB by the first device may be an integer multiple (M times) of the preset bandwidth. An SSB bandwidth size or a value of M may be selected from a preset set, that is, the first device may transmit the SSB within a limited set of bandwidths.

Embodiment 2 of this application: determine an actual transmit bandwidth of an SSB

As described in Embodiment 1, if the first device uses a relatively large deployment bandwidth, the SSB may be transmitted by using a larger bandwidth. In this case, the second device can still detect the SSB by receiving the SSB by using the preset bandwidth.

Receiving of the SSB is a periodic behavior for measurement, synchronization, automatic gain control (Automatic Gain Control, AGC), and the like. Therefore, after receiving the SSB, the second device may obtain, by using indication information of the first device, a bandwidth actually used by the first device to transmit the SSB, where the bandwidth may be used to improve reliability of subsequent SSB receiving.

Optionally, the indication information is indicated by using the SSB or system information. The indication information is indicated by using the SSB, so that the SSB receive end can obtain the indication information while obtaining the SSB, which is convenient and fast. In this embodiment of this application, the system information may be information sent independently of the SSB, or may be system information carried by the SSB. This is not limited in this application. The system information is, for example, a master information block (master information block, MIB) or a system information block (System Information Block, SIB).

In some embodiments, optionally, that the indication information is indicated by using the SSB includes one of the following:
the indication information is indicated by using a synchronization sequence in the SSB;
the indication information is indicated by using an information bit (payload part) of a physical broadcast channel (PBCH) in the SSB; and
the indication information is indicated through cyclic redundancy check (CRC) scrambling of the information bit of the physical broadcast channel in the SSB.

After obtaining the transmit bandwidth information of the SSB, the second device may perform subsequent SSB receiving by using a larger bandwidth.

The first device transmits other channels in the SSB by using a same bandwidth. In this case, after receiving the indication information, the second device receives at least one piece of the following information by using the bandwidth indicated in the indication information, to improve receiving performance:
the SSB;
the physical broadcast channel;
a control channel;
a data channel; and
a measurement signal, where the measurement signal may include, for example, at least one of the following: a measurement reference signal and a demodulation reference signal.

Embodiment 3 of this application: Use different radio resource management (Radio Resource Management, RRM) metrics under different bandwidths.

The second device may have different receive bandwidth capabilities. The second device (A-IoT device, low-power terminal device) may report the receive bandwidth capability. Optionally, the receive bandwidth capability may include at least one of the following: a supported bandwidth size and a set of supported receive bandwidths. The preset bandwidth is a receiving capability of all devices, and the capability may not be reported. However, a receiving capability that is higher than the preset bandwidth may be reported, which facilitates subsequent transmission by the transmit device by using an appropriate bandwidth.

For second devices that have different bandwidth capabilities, some receiving metrics are also different because receiving quality is different. For example, a device that has only a capability of the preset bandwidth is limited by a relatively small receive bandwidth, and needs to receive the SSB or the measurement signal a plurality of times to obtain measurement performance that meets a requirement. As a result, a time for synchronization, reselection, or handover becomes longer. A device with a relatively large receive bandwidth may meet a measurement performance requirement by using a relatively small quantity of receiving times. Therefore, a time for synchronization, reselection, or handover is also relatively short.

Optionally, the second device determines an applicable receiving metric based on the receive bandwidth capability of the second device, for example, a measurement accuracy metric, a measurement evaluation period, a reporting period, or a quantity of measurements per unit period.

For example, a device with a relatively small bandwidth capability uses a relatively long measurement evaluation period or a relatively long reporting period, or needs to perform a larger quantity of measurements per unit period. A device with a relatively large bandwidth capability uses a relatively short measurement evaluation period or a relatively short reporting period, or needs to perform a smaller quantity of measurements per unit period.

Embodiment 4 of this application: Indication of a transmit bandwidth X in a case that the transmit bandwidth is less than or equal to a receive bandwidth Y

For an OOK signal, when determining of the transmit bandwidth is affected by another communication system (for example, NR) on an adjacent frequency, to reduce an impact of the OOK signal on the NR signal, referring to FIG. 14, a bandwidth of the OOK signal sent by the transmit device (namely, the first device) may be less than or equal to the receive bandwidth of the IoT device or the low-power receive device (namely, the second device). In this case, the receive device can still detect the OOK channel. However, because the receive bandwidth is greater than the actual transmit bandwidth of OOK, more noise and interference power are included in a receive filter. As a result, receiving performance may be degraded to some extent.

For SSB sending, the transmit bandwidth X may be less than the preset bandwidth Y for receiving, namely, the bandwidth of the receive filter. After the receive device completes SSB receiving, the sequence part or the payload part in the SSB may carry indication information of the actual transmit bandwidth X.

After receiving the indication information, the IoT device or the low-power device restricts the sent signal within the bandwidth X, and determines, based on the indicated bandwidth X, a sending metric that needs to be met, for example, an in-band emission (in-band emission) metric, an adjacent channel leakage ratio (Adjacent Channel Leakage Ratio, ACLR) metric, or a spurious (spurious) metric, to avoid an impact of the signal sent by the device on another communication system on an adjacent frequency.

The SSB transmission method provided in the embodiments of this application may be performed by an SSB transmission apparatus. In the embodiments of this application, the SSB transmission apparatus provided in the embodiments of this application is described by using an example in which the SSB transmission apparatus performs the SSB transmission method.

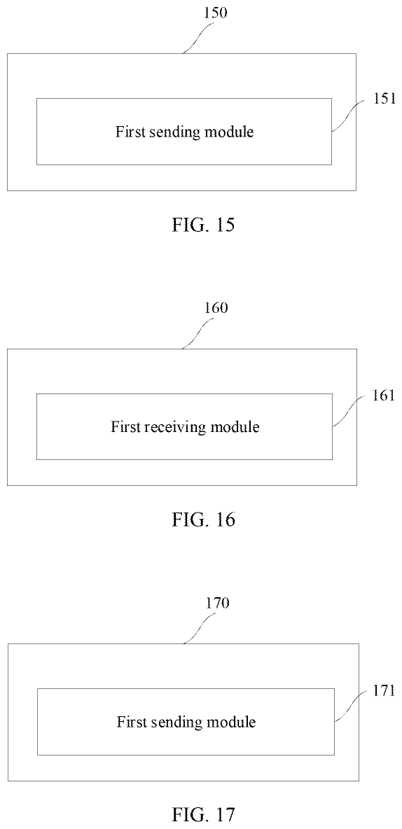

Referring to FIG. 15, an embodiment of this application further provides an SSB transmission apparatus 150, including:
a first sending module 151, configured to send an SSB by using a first bandwidth, where the first bandwidth is greater than or equal to a preset bandwidth, and the preset bandwidth is an initial receive bandwidth used by a second device to receive the SSB.

In this embodiment of this application, an SSB transmit end sends the SSB by using the first bandwidth greater than or equal to the preset bandwidth, and the preset bandwidth is the initial receive bandwidth used by an SSB receive end, so that more reliable transmission performance can be obtained by using a larger bandwidth.

Optionally, the first bandwidth is M times the preset bandwidth, and M is greater than or equal to 1.

Optionally, the SSB transmission apparatus 150 further includes:
a first selection module, configured to select the first bandwidth from a preset set of first bandwidths;
or
a second selection module, configured to: select M from a preset set of multiples, and determine the first bandwidth based on the selected M and the preset bandwidth, where the first bandwidth is M times the preset bandwidth, and M is greater than or equal to 1.

Optionally, the SSB transmission apparatus 150 further includes:
a second sending module, configured to send indication information, where the indication information is used to indicate the first bandwidth or M, the first bandwidth is M times the preset bandwidth, and M is greater than or equal to 1.

Optionally, the indication information is indicated by using the SSB or system information.

Optionally, that the indication information is indicated by using the SSB includes one of the following:
the indication information is indicated by using a synchronization sequence in the SSB;
the indication information is indicated by using an information bit of a physical broadcast channel in the SSB; and
the indication information is indicated through cyclic redundancy check (CRC) scrambling of the information bit of the physical broadcast channel in the SSB.

Optionally, the SSB includes at least one of the synchronization sequence and the physical broadcast channel.

Optionally, the first sending module 151 is configured to send the synchronization sequence and the physical broadcast channel by using different periods.

Optionally, the SSB transmission apparatus 150 further includes:
a third sending module, configured to send at least one of the following by using the first bandwidth:
a control channel;
a data channel; and
a measurement signal.

Optionally, the SSB transmission apparatus 150 further includes:
a receiving module, configured to receive capability information of the second device, where the capability information includes a receive bandwidth capability of the second device; and
a determining module, configured to determine the first bandwidth based on the receive bandwidth capability of the second device.

Optionally, the first sending module 151 is configured to send the SSB by using an on-off keying (OOK) or amplitude-shift keying (ASK) waveform.

The SSB transmission apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The SSB transmission apparatus provided in this embodiment of this application can implement the processes implemented in the method embodiment of FIG. 8, and achieve the same technical effects. To avoid repetition, details are not described herein again.

Referring to FIG. 16, an embodiment of this application further provides an SSB transmission apparatus 160, including:
a first receiving module 161, configured to receive an SSB by using a preset bandwidth, where the preset bandwidth is less than or equal to a first bandwidth, and the first bandwidth is a bandwidth used by a first device to send the SSB.

In this embodiment of this application, an SSB receive end receives the SSB by using the preset bandwidth, where the preset bandwidth is less than or equal to the first bandwidth, and the first bandwidth is a bandwidth used by the first device to send the SSB. Therefore, the receive end can receive a signal by using the preset bandwidth in a case that the receive end does not know an actual transmit bandwidth of a low-power signal, without increasing receiver complexity, and the receive end can still receive the SSB, thereby reducing receiving complexity of the SSB, and improving downlink channel transmission performance.

Optionally, the first bandwidth is M times the preset bandwidth, and M is greater than or equal to 1.

Optionally, the SSB transmission apparatus 160 further includes:
a second receiving module, configured to receive indication information, where the indication information is used to indicate the first bandwidth or M, the first bandwidth is M times the preset bandwidth, and M is greater than or equal to 1.

Optionally, the indication information is indicated by using the SSB or system information.

Optionally, that the indication information is indicated by using the SSB includes one of the following:
the indication information is indicated by using a synchronization sequence in the SSB;
the indication information is indicated by using an information bit of a physical broadcast channel in the SSB; and
the indication information is indicated through CRC scrambling of the information bit of the physical broadcast channel in the SSB.

Optionally, the SSB transmission apparatus 160 further includes:
a third receiving module, configured to receive at least one piece of the following information by using the first bandwidth:
the SSB;
the physical broadcast channel;
a control channel;
a data channel; and
a measurement signal.

Optionally, the SSB transmission apparatus 160 further includes:
a determining module, configured to determine a receiving metric based on at least one of the first bandwidth and the preset bandwidth.

Optionally, the receiving metric includes at least one of the following:
a measurement accuracy metric;
a measurement evaluation period;
a measurement result reporting period; and
a quantity of measurements per unit period.

Optionally, the SSB transmission apparatus 160 further includes:
a sending module, configured to report capability information of the second device, where the capability information includes a receive bandwidth capability of the second device.

Optionally, the SSB is transmitted by using an OOK or ASK waveform.

The SSB transmission apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The SSB transmission apparatus provided in this embodiment of this application can implement the processes implemented in the method embodiment of FIG. 10, and achieve the same technical effects. To avoid repetition, details are not described herein again.

Referring to FIG. 17, an embodiment of this application further provides an SSB transmission apparatus 170, including:
a first sending module 171, configured to send an SSB by using a first bandwidth, where the first bandwidth is less than or equal to a preset bandwidth.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

Optionally, the SSB transmission apparatus 170 further includes:
a selection module, configured to select the first bandwidth from a preset set of first bandwidths.

Optionally, the SSB transmission apparatus 170 further includes:
a second sending module, configured to send indication information, where the indication information is used to indicate the first bandwidth.

Optionally, the indication information is indicated by using the SSB or system information.

Optionally, that the indication information is indicated by using the SSB includes one of the following:
the indication information is indicated by using a synchronization sequence in the SSB;
the indication information is indicated by using an information bit of a physical broadcast channel in the SSB; and
the indication information is indicated through CRC scrambling of the information bit of the physical broadcast channel in the SSB.

Optionally, the SSB transmission apparatus 170 further includes:
a receiving module, configured to receive, by using the first bandwidth, a signal sent by the second device.

Optionally, the SSB includes at least one of the synchronization sequence and the physical broadcast channel.

Optionally, the first sending module 171 is configured to send the synchronization sequence and the physical broadcast channel by using different periods.

Optionally, the SSB transmission apparatus 170 further includes:
sending, by the first device, at least one of the following by using the first bandwidth:
a control channel;
a data channel; and
a measurement signal.

Optionally, the first sending module 171 is configured to send the SSB by using an OOK or ASK waveform.

The SSB transmission apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The SSB transmission apparatus provided in this embodiment of this application can implement the processes implemented in the method embodiment of FIG. 11, and achieve the same technical effects. To avoid repetition, details are not described herein again.

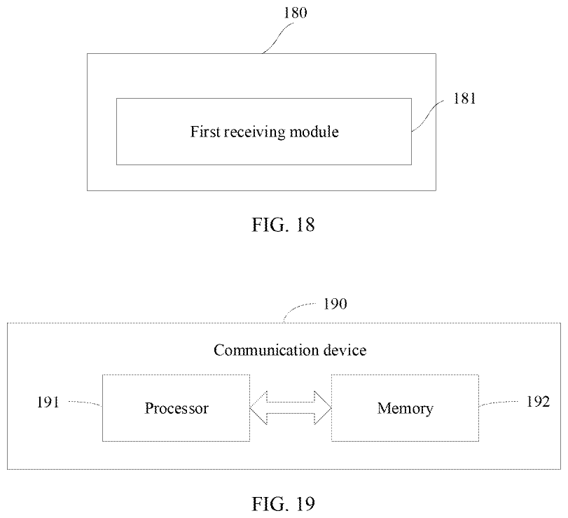

Referring to FIG. 18, an embodiment of this application further provides an SSB transmission apparatus 180, including:
a first receiving module 181, configured to receive an SSB by using a preset bandwidth, where the preset bandwidth is greater than or equal to a first bandwidth, and the first bandwidth is a bandwidth used by a first device to send the SSB.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

Optionally, the SSB transmission apparatus 180 further includes:
a second receiving module, configured to receive indication information, where the indication information is used to indicate the first bandwidth.

Optionally, the indication information is indicated by using the SSB or system information.

Optionally, that the indication information is indicated by using the SSB includes one of the following:
the indication information is indicated by using a synchronization sequence in the SSB;
the indication information is indicated by using an information bit of a physical broadcast channel in the SSB; and
the indication information is indicated through CRC scrambling of the information bit of the physical broadcast channel in the SSB.

Optionally, the SSB transmission apparatus 180 further includes:
a sending module, configured to send a signal by using the first bandwidth.

Optionally, the SSB transmission apparatus 180 further includes:
a determining module, configured to determine a sending metric of the signal based on the first bandwidth.

Optionally, the sending metric includes at least one of the following:
an in-band emission metric;
an adjacent channel leakage ratio metric; and
a spurious metric.

Optionally, the SSB is transmitted by using an OOK or ASK waveform.

The SSB transmission apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in this embodiment of this application.

The SSB transmission apparatus provided in this embodiment of this application can implement the processes implemented in the method embodiment of FIG. 12, and achieve the same technical effects. To avoid repetition, details are not described herein again.

As shown in FIG. 19, an embodiment of this application further provides a communication device 190, including a processor 191 and a memory 192. The memory 192 stores a program or instructions capable of running on the processor 191. The program or the instructions are executed by the processor 191 to implement the steps of the foregoing SSB transmission method embodiment, and the same technical effects can be achieved. To avoid repetition, details are not described herein again.

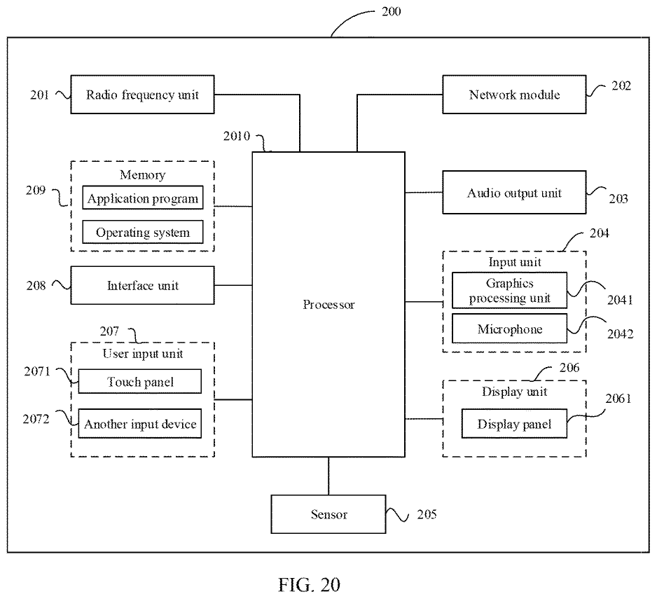

An embodiment of this application further provides a terminal, including a processor and a communication interface. The communication interface is coupled to the processor, and the processor is configured to run a program or instructions to implement the steps of the method embodiment shown in FIG. 8, FIG. 10, FIG. 11, or FIG. 12. The terminal embodiment corresponds to the foregoing terminal-side method embodiment. Implementation processes and implementations of the foregoing method embodiment may be applied to the terminal embodiment, and the same technical effects can be achieved. Specifically, FIG. 20 is a schematic diagram of a hardware structure of a terminal for implementing an embodiment of this application.

The terminal 200 includes but is not limited to at least some components in a radio frequency unit 201, a network module 202, an audio output unit 203, an input unit 204, a sensor 205, a display unit 206, a user input unit 207, an interface unit 208, a memory 209, and a processor 2010.

A person skilled in the art may understand that the terminal 200 may further include a power supply (for example, a battery) that supplies power to each component. The power supply may be logically connected to the processor 2010 through a power management system, to implement functions such as charging management, discharging management, and power consumption management through the power management system. The structure of the terminal shown in FIG. 20 does not constitute a limitation on the terminal. The terminal may include more or fewer components than those shown in the figure, or combine some components, or have different component arrangements. Details are not described herein again.

It should be understood that in this embodiment of this application, the input unit 204 may include a graphics processing unit (Graphics Processing Unit, GPU) 2041 and a microphone 2042, and the graphics processing unit 2041 processes image data of a still picture or a video obtained by an image capture apparatus (for example, a camera) in a video capture mode or an image capture mode. The display unit 206 may include a display panel 2061, and the display panel 2061 may be configured in a form of a liquid crystal display, an organic light-emitting diode, or the like. The user input unit 207 includes at least one of a touch panel 2071 and another input device 2072. The touch panel 2071 is also referred to as a touchscreen. The touch panel 2071 may include two parts: a touch detection apparatus and a touch controller. The another input device 2072 may include but is not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 201 may transmit the downlink data to the processor 2010 for processing. In addition, the radio frequency unit 201 may send uplink data to the network-side device. Generally, the radio frequency unit 201 includes but is not limited to an antenna, an amplifier, a transceiver, a coupler, a low-noise amplifier, a duplexer, and the like.

The memory 209 may be configured to store a software program or instructions and various types of data. The memory 209 may mainly include a first storage area for storing a program or instructions and a second storage area for storing data. The first storage area may store an operating system, an application program or instructions required by at least one function (for example, a sound playback function or an image playback function), and the like. In addition, the memory 209 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 209 in this embodiment of this application includes but is not limited to these memories and any other suitable type of memory.

The processor 2010 may include one or more processing units. Optionally, the processor 2010 integrates an application processor and a modem processor. The application processor mainly processes operations related to an operating system, a user interface, an application program, and the like. The modem processor, for example, a baseband processor, mainly processes a wireless communication signal. It may be understood that the foregoing modem processor may not be integrated into the processor 2010.

The radio frequency unit 201 is configured to send an SSB by using a first bandwidth, where the first bandwidth is greater than or equal to a preset bandwidth, and the preset bandwidth is an initial receive bandwidth used by a second device to receive the SSB.

In this embodiment of this application, an SSB transmit end sends the SSB by using the first bandwidth greater than or equal to the preset bandwidth, and the preset bandwidth is the initial receive bandwidth used by an SSB receive end, so that more reliable transmission performance can be obtained by using a larger bandwidth.

The radio frequency unit 201 is configured to receive an SSB by using a preset bandwidth, where the preset bandwidth is less than or equal to a first bandwidth, and the first bandwidth is a bandwidth used by a first device to send the SSB.

In this embodiment of this application, an SSB receive end receives the SSB by using the preset bandwidth, where the preset bandwidth is less than or equal to the first bandwidth, and the first bandwidth is a bandwidth used by the first device to send the SSB. Therefore, the receive end can receive a signal by using the preset bandwidth in a case that the receive end does not know an actual transmit bandwidth of a low-power signal, without increasing receiver complexity, and the receive end can still receive the SSB, thereby reducing receiving complexity of the SSB, and improving downlink channel transmission performance.

Alternatively, the radio frequency unit 201 is configured to send an SSB by using a first bandwidth, where the first bandwidth is less than or equal to a preset bandwidth.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

The radio frequency unit 201 is configured to receive an SSB by using a preset bandwidth, where the preset bandwidth is greater than or equal to a first bandwidth, and the first bandwidth is a bandwidth used by a first device to send the SSB.

In this embodiment of this application, a transmit bandwidth used by a transmit end to send the SSB may be less than a receive bandwidth of a receive end, and the receive end can still detect the SSB, thereby reducing an impact on a signal of another communication system on an adjacent frequency.

It may be understood that for implementation processes of the implementations mentioned in this embodiment, references may be made to related descriptions in the method embodiment in FIG. 8, FIG. 10, FIG. 11, or FIG. 12, and same or corresponding technical effects are achieved. To avoid repetition, details are not described herein again.

An embodiment of this application further provides a network-side device, including a processor and a communication interface. The communication interface is coupled to the processor. The processor is configured to run a program or instructions to implement the steps of the method embodiment shown in FIG. 8 or FIG. 11. The network-side device embodiment corresponds to the method embodiment of the foregoing first device. Implementation processes and implementations of the foregoing method embodiment may be applied to the network-side device embodiment, and the same technical effects can be achieved.

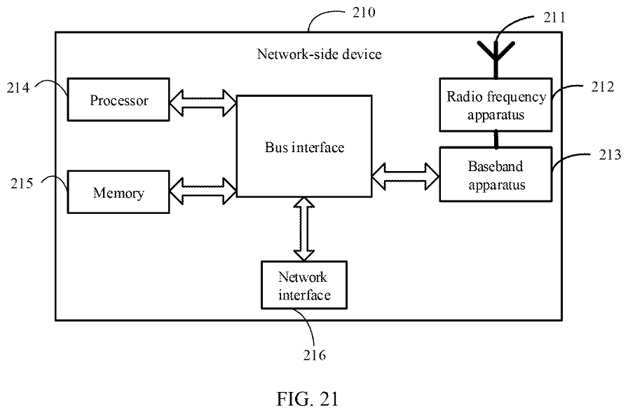

Specifically, an embodiment of this application further provides a network-side device. As shown in FIG. 21, a network-side device 210 includes an antenna 211, a radio frequency apparatus 212, a baseband apparatus 213, a processor 214, and a memory 215. The antenna 211 is connected to the radio frequency apparatus 212. In an uplink direction, the radio frequency apparatus 212 receives information by using the antenna 211, and sends the received information to the baseband apparatus 213 for processing. In a downlink direction, the baseband apparatus 213 processes to-be-sent information, and sends the processed information to the radio frequency apparatus 212. After processing the received information, the radio frequency apparatus 212 sends the processed information by using the antenna 211.

The method performed by a network-side device in the foregoing embodiment may be implemented in the baseband apparatus 213. The baseband apparatus 213 includes a baseband processor.

For example, the baseband apparatus 213 may include at least one baseband board. A plurality of chips are disposed on the baseband board. As shown in FIG. 21, one of the chips is, for example, the baseband processor, and is connected to the memory 215 by using a bus interface, to invoke a program in the memory 215 to perform an operation of a network device shown in the foregoing method embodiment.

The network-side device may further include a network interface 216, and the interface is, for example, a common public radio interface (Common Public Radio Interface, CPRI).

Specifically, the network-side device 210 in this embodiment of this application further includes instructions or a program stored in the memory 215 and capable of running on the processor 214. The processor 214 invokes the instructions or the program in the memory 215 to perform the method performed by the modules shown in FIG. 15 or FIG. 17, and the same technical effects are achieved. To avoid repetition, details are not described herein again.

An embodiment of this application further provides a readable storage medium. The readable storage medium stores a program or instructions. The program or the instructions are executed by a processor to implement the processes in the foregoing SSB transmission method embodiment, and the same technical effects can be achieved. To avoid repetition, details are not described herein again.

The processor is a processor in the terminal described in the foregoing embodiments. The readable storage medium includes a computer-readable storage medium such as a computer read-only memory (ROM), a random access memory (RAM), a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes in the foregoing the SSB transmission method embodiment, and the same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing SSB transmission method embodiment, and the same technical effects can be achieved. To avoid repetition, details are not described herein again.

An embodiment of this application further provides a communication system, including a first device and a second device. The first device may be configured to perform the steps of the foregoing SSB transmission method performed by the first device, and the second device may be configured to perform the steps of the foregoing SSB transmission method performed by the second device.

It should be noted that in this specification, the term “include”, “comprise”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more limitations, an element preceded by “includes a . . . ” does not preclude the existence of additional identical elements in the process, method, article, or apparatus that includes the element. In addition, it should be noted that the scope of the methods and apparatuses in the implementations of this application is not limited to performing functions in a sequence shown or discussed, and may further include performing functions in a basically simultaneous manner or in a reverse sequence based on related functions. For example, the described methods may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network-side device to perform the method described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A synchronization signal block (SSB) transmission method, comprising:
sending, by a first device, an SSB by using a first bandwidth, wherein the first bandwidth is greater than or equal to a preset bandwidth, and the preset bandwidth is an initial receive bandwidth used by a second device to receive the SSB.

2. The method according to claim 1, wherein the first bandwidth is M times the preset bandwidth, and M is greater than or equal to 1.

3. The method according to claim 1, further comprising:
selecting, by the first device, the first bandwidth from a preset set of first bandwidths;
or
selecting, by the first device, M from a preset set of multiples, and determining the first bandwidth based on the selected M and the preset bandwidth, wherein the first bandwidth is M times the preset bandwidth, and M is greater than or equal to 1.

4. The method according to claim 1, further comprising:
sending, by the first device, indication information, wherein the indication information is used to indicate the first bandwidth or M, the first bandwidth is M times the preset bandwidth, and M is greater than or equal to 1.

5. The method according to claim 4, wherein the indication information is indicated by using the SSB or system information.

6. The method according to claim 5, wherein that the indication information is indicated by using the SSB comprises one of the following:
the indication information is indicated by using a synchronization sequence in the SSB;
the indication information is indicated by using an information bit of a physical broadcast channel in the SSB; and
the indication information is indicated through cyclic redundancy check (CRC) scrambling of the information bit of the physical broadcast channel in the SSB.

7. The method according to claim 1, further comprising:
sending, by the first device, at least one of the following by using the first bandwidth:
a control channel;
a data channel; and
a measurement signal.

8. The method according to claim 1, further comprising:
receiving, by the first device, capability information of the second device, wherein the capability information comprises a receive bandwidth capability of the second device; and
determining, by the first device, the first bandwidth based on the receive bandwidth capability of the second device.

9. The method according to claim 1, wherein the sending, by the first device, the SSB by using the first bandwidth comprises:
sending, by the first device, the SSB by using an on-off keying (OOK) or amplitude-shift keying (ASK) waveform.

10. An synchronization signal block (SSB) transmission method, comprising:
receiving, by a second device, an SSB by using a preset bandwidth, wherein the preset bandwidth is less than or equal to a first bandwidth, and the first bandwidth is a bandwidth used by a first device to send the SSB.

11. The method according to claim 10, wherein the first bandwidth is M times the preset bandwidth, and M is greater than or equal to 1.

12. The method according to claim 10, further comprising:
receiving, by the second device, indication information, wherein the indication information is used to indicate the first bandwidth or M, the first bandwidth is M times the preset bandwidth, and M is greater than or equal to 1.

13. The method according to claim 12, wherein the indication information is indicated by using the SSB or system information.

14. The method according to claim 12, wherein after the second device receives the indication information, the method further comprises:
receiving, by the second device, at least one piece of the following information by using the first bandwidth:
the SSB;
a physical broadcast channel;
a control channel;
a data channel; and
a measurement signal.

15. The method according to claim 12, further comprising:
determining, by the second device, a receiving metric based on at least one of the first bandwidth and the preset bandwidth.

16. The method according to claim 15, wherein the receiving metric comprises at least one of the following:
a measurement accuracy metric;
a measurement evaluation period;
a measurement result reporting period; and
a quantity of measurements per unit period.

17. The method according to claim 10, further comprising:
reporting, by the second device, capability information of the second device, wherein the capability information comprises a receive bandwidth capability of the second device.

18. The method according to claim 10, wherein the SSB is transmitted by using an on-off keying (OOK) or amplitude-shift keying (ASK) waveform.

19. A communication device, comprising a processor and a memory, wherein the memory stores a program or instructions capable of running on the processor, and the program or the instructions are executed by the processor to implement the steps of the SSB transmission method according to claim 10.

20. A communication device, comprising a processor and a memory, wherein the memory stores a program or instructions capable of running on the processor, and the program or the instructions are executed by the processor to cause the communication device to:
send an synchronization signal block (SSB) by using a first bandwidth, wherein the first bandwidth is greater than or equal to a preset bandwidth, and the preset bandwidth is an initial receive bandwidth used by a second device to receive the SSB.
